(19) United States
(12) Patent Application Publication
(10) Pub. No.: US 2016/0212282 A1
(43) Pub. Date: Jul. 21, 2016

(54) NON-TRANSITORY COMPUTER READABLE MEDIUM, INFORMATION PROCESSING APPARATUS, AND INFORMATION PROCESSING METHOD

(71) Applicant: FUJI XEROX CO., LTD., Tokyo (JP)

(72) Inventors: Hidejiro SHIKAZE, Kanagawa (JP); Tsukasa TSUSHIMA, Kanagawa (JP); Kazuhiko ABE, Kanagawa (JP); Masaharu SHIMOJIMA, Kanagawa (JP)

(73) Assignee: FUJI XEROX CO., LTD., Tokyo (JP)

(21) Appl. No.: 14/827,435

(22) Filed: Aug. 17, 2015

(30) Foreign Application Priority Data
Jan. 21, 2015 (JP) 2015-009260

(51) Int. Cl. H04N 1/00; H04N 1/04

(52) U.S. Cl. CPC H04N 1/00244; H04N 1/00347; H04N 1/0461; H04N 2201/0081

(57) ABSTRACT

A non-transitory computer readable medium stores a program causing a computer to execute a process for content management. In the process, an instruction to reset or update distribution setting information of document information or an instruction to delete the document information is received by causing an image forming apparatus to read again a setting sheet after the document information and the distribution setting information of the document information are received. The setting sheet is a sheet on which the distribution setting information is described. When the instruction to reset or update the distribution setting information is received, the document information and the reset or updated distribution setting information are distributed to a signage controller for displaying the document information.

### CROSS-REFERENCE TO RELATED APPLICATIONS

This application is based on and claims priority under 35 USC 119 from Japanese Patent Application No. 2015-009260 filed Jan. 21, 2015.

### BACKGROUND

(i) Technical Field

The present invention relates to a non-transitory computer readable medium, an information processing apparatus, and an information processing method.

(ii) Related Art

In the related art, an information processing apparatus that performs text recognition on a handwritten document and a handwritten distribution date and time which are received by using a fax and that distributes email about the recognition result to preregistered members has been proposed.

### SUMMARY

According to an aspect of the invention, there is provided a non-transitory computer readable medium storing a program causing a computer to execute a process for content management. The process includes receiving an instruction to reset or update distribution setting information of document information or an instruction to delete the document information, by causing an image forming apparatus to read again a setting sheet after the document information and the distribution setting information of the document information are received, the setting sheet being a sheet on which the distribution setting information is described; and distributing the document information and the reset or updated distribution setting information to a signage controller for displaying the document information, when the instruction to reset or update the distribution setting information is received.

### BRIEF DESCRIPTION OF THE DRAWINGS

Exemplary embodiments of the present invention will be described in detail based on the following figures, wherein:

FIG. 1 is a schematic view of an exemplary configuration of a content managing system according to a first exemplary embodiment;

FIG. 2 is a block diagram illustrating an exemplary configuration of a content managing server according to the first exemplary embodiment;

FIG. 3 is a schematic view of an exemplary structure of content management information;

FIGS. 4A to 4D are diagrams for describing exemplary operations in the content managing system;

FIG. 5 is a schematic view of an exemplary configuration of a setting sheet;

FIG. 6 is a schematic view of another exemplary configuration of the setting sheet;

FIG. 7 is a flowchart of exemplary operations performed by the content managing server when posting is performed;

FIG. 8 is a flowchart of exemplary operations performed by the content managing server when posting is performed again;

FIGS. 9A to 9D are diagrams for describing exemplary operations performed in a content managing system according to a second exemplary embodiment;

FIG. 10 is a schematic view of an exemplary configuration of a setting sheet; and

FIGS. 11A to 11D are diagrams for describing exemplary operations performed in a content managing system according to a third exemplary embodiment.

### DETAILED DESCRIPTION

### First Exemplary Embodiment

Configuration of Content Managing System

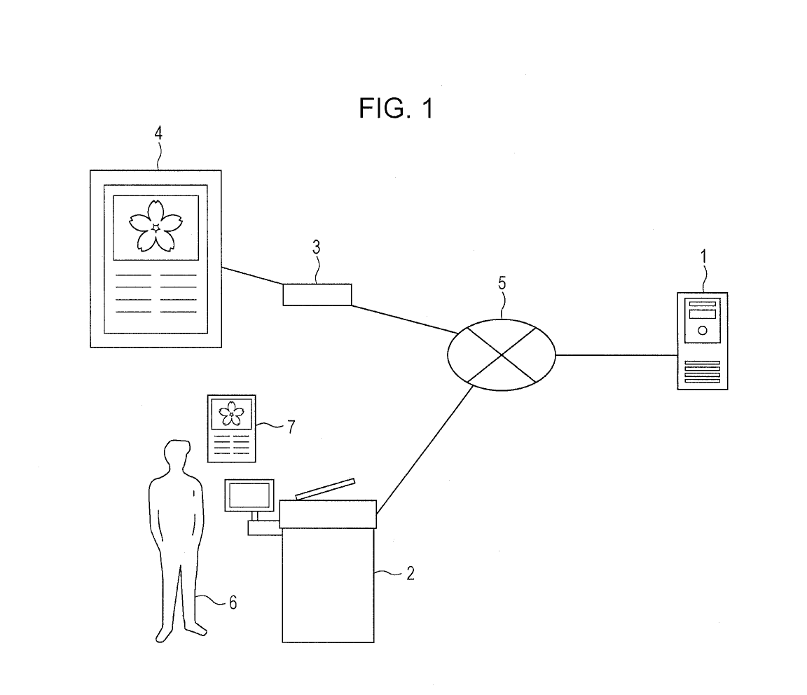

FIG. 1 is a schematic view of an exemplary configuration of a content managing system according to a first exemplary embodiment.

The content managing system includes a content managing server 1, an image forming apparatus 2, and a signage controller 3 which are connected to one another through a network 5 so as to communicate with one another. The image forming apparatus 2 is operated by a user 6.

The content managing server 1 which is an information processing apparatus serving as a server and which operates in response to a request from the image forming apparatus 2 includes electronic components, such as a central processing unit (CPU) having a function for processing information and a hard disk for storing information, in the body thereof. The content managing server 1 controls the signage controller 3.

The image forming apparatus 2 has at least a scan function, a print function, and an external communication function, and includes functional units for achieving the above-described functions, and electronic components, such as a CPU and a dynamic random access memory (DRAM), in the body thereof.

The signage controller 3 which controls a display apparatus 4 so that images and characters are displayed, and which receives information necessary for the display by communicating with the content managing server 1 includes electronic components, such as a CPU and a DRAM.

The network 5 is a communication network and is, for example, a wired or wireless communication network, such as the Internet, an intranet, or a local area network (LAN).

In the above-described configuration, when the user 6 uses the image forming apparatus 2 to scan a document 7, document information generated by scanning the document 7 is transmitted to the content managing server 1, and is stored. The user 6 writes a distribution time or the like of the document information on a setting sheet described below, and scans the setting sheet by using the image forming apparatus 2. Then, distribution setting information generated through the scanning is transmitted to the content managing server 1, and is stored. The content managing server 1 distributes the document information and the distribution setting information to the signage controller 3, and the signage controller 3 causes the document information to be displayed on the display apparatus 4 on the basis of the distribution setting information. Some or all of the functions of the content managing server 1 may be included in the image forming apparatus 2 or the signage controller 3.

### Configuration of Content Managing Server

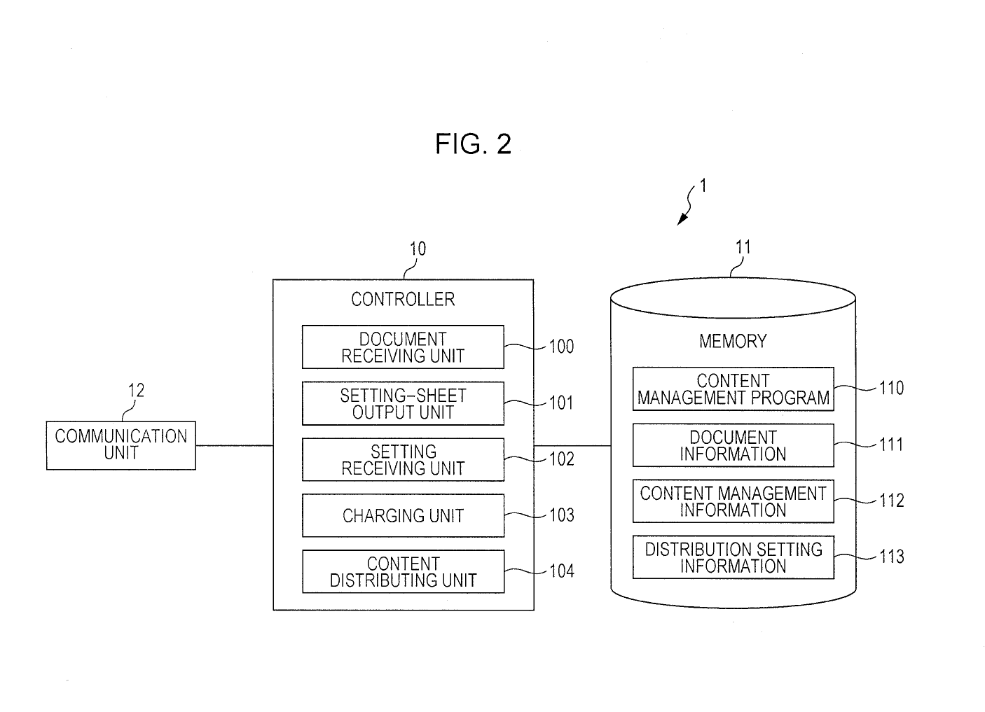

FIG. 2 is a block diagram illustrating an exemplary configuration of the content managing server 1 according to the first exemplary embodiment.

The content managing server 1 includes a controller 10 which includes a CPU, which controls the units, and which executes various programs, a memory 11 which includes a storage medium such as a hard disk and which is used to store information, and a communication unit 12 which communicates with the outside via a network.

The controller 10 executes a content management program 110 described below, thereby functioning as a document receiving unit 100, a setting-sheet output unit 101, a setting receiving unit 102, a charging unit 103, a content distributing unit 104, and the like.

The document receiving unit 100 receives document information obtained by scanning the document 7 on the image forming apparatus 2, from the image forming apparatus 2, and stores the document information as document information 111 in the memory 11.

When the document receiving unit 100 receives the document information 111, the setting-sheet output unit 101 causes the image forming apparatus 2 to output a setting sheet for setting a distribution condition of the document information 111.

The setting receiving unit 102 receives distribution setting information obtained by scanning the setting sheet on the image forming apparatus 2, and stores the distribution setting information as distribution setting information 113 in the memory 11. The setting receiving unit 102 may include a unit that recognizes setting specified in image information obtained by scanning the setting sheet and that converts the recognized result into distribution setting information, or the image forming apparatus 2 may perform such conversion.

After the setting receiving unit 102 stores the distribution setting information 113, the charging unit 103 performs a charging process in the image forming apparatus 2.

When the charging unit 103 completes the charging process, the content distributing unit 104 distributes the document information 111 and the distribution setting information 113 to the signage controller 3.

The memory 11 is used to store the content management program 110 which causes the controller 10 to function as the above-described units 100 to 104, the document information 111, content management information 112, the distribution setting information 113, and the like.

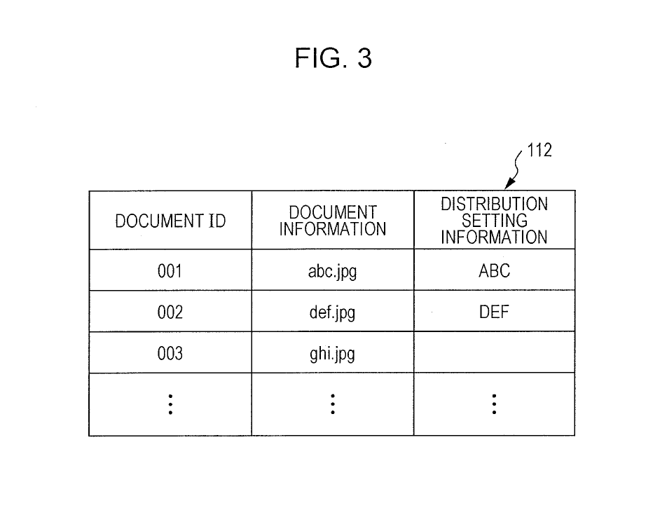

FIG. 3 is a schematic view of an exemplary structure of the content management information 112.

In the content management information 112, a document ID for identifying the document information 111, the file name of the document information, and the file name of the distribution setting information are stored in such a manner as to be associated with one another.

### Operations in Content Managing System

Actions according to the first exemplary embodiment will be described by classifying them into (1) document-information registration operations, (2) distribution-setting-information registration operations, (3) charging operations, (4) distribution operations, and (5) reregistration operations.

### (1) Document-Information Registration Operations

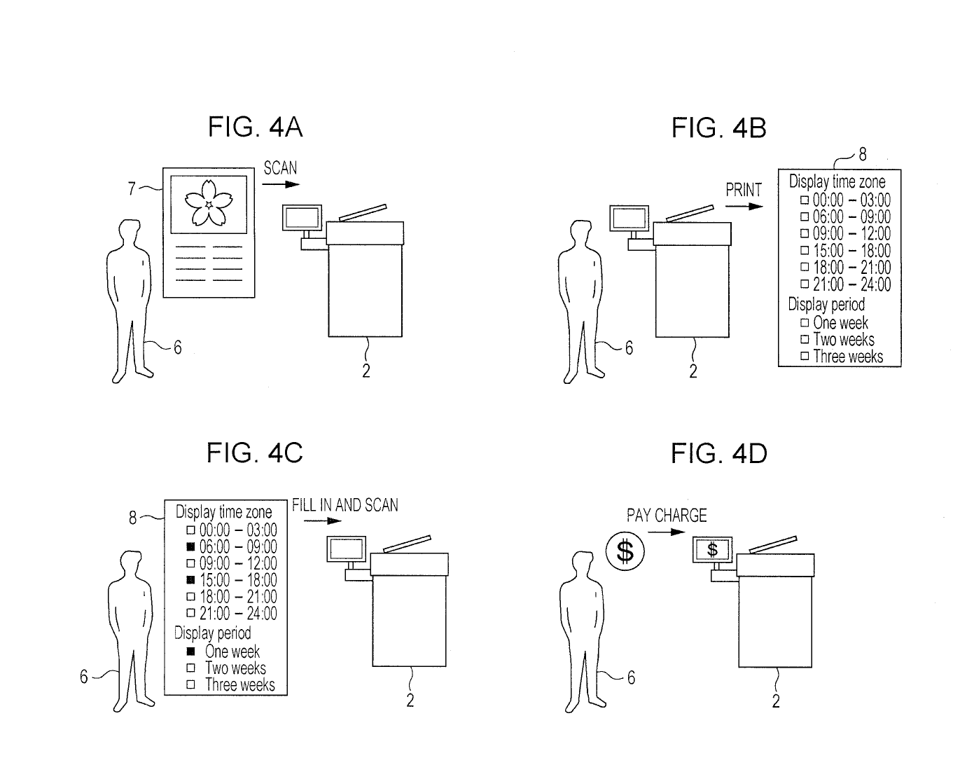

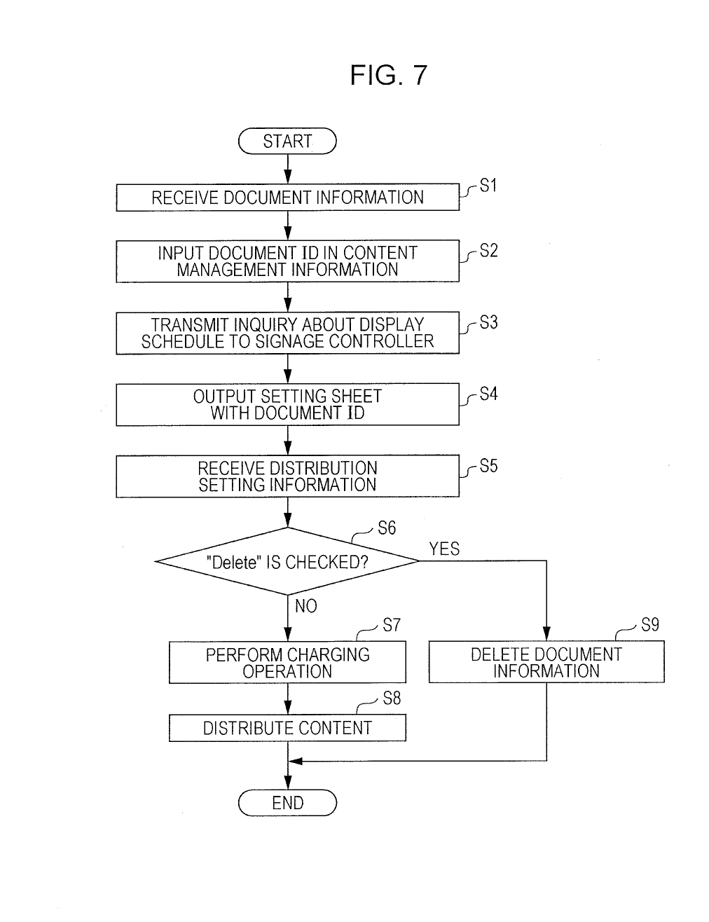

FIGS. 4A to 4D are diagrams for describing exemplary operations performed in the content managing system. FIG. 7 is a flowchart of exemplary operations performed by the content managing server 1 when posting is performed.

As illustrated in FIG. 4A, the user 6 uses the image forming apparatus 2 to scan the document 7.

The image forming apparatus 2 scans the document 7 to generate document information, and transmits the document information to the content managing server 1.

The document receiving unit 100 of the content managing server 1 receives the document information from the image forming apparatus 2, and stores the document information as the document information 111 in the memory 11 (S1).

At that time, the document receiving unit 100 inputs a new document ID in the content management information 112 illustrated in FIG. 3, and associates the document ID with the document information (S2). For example, the document receiving unit 100 inputs a document ID of “003” for the document information whose document information name is “ghi.jpg”. At this time point, the distribution setting information field is set to blank because no distribution setting information has been associated with the document information.

### (2) Distribution-Setting-Information Registration Operations

Then, the setting-sheet output unit 101 transmits an inquiry about a display schedule to the signage controller 3 to check the display schedule of the signage controller 3 (S3). For example, assume that a response is received which indicates that the time zone “03:00 to 06:00” corresponds to “off hours”, that the time zone “12:00 to 15:00” is “unavailable because other post documents are displayed”, and that the other time zones are available. The term “posting” indicates some or all of the procedures performed by the user 6 so as to display the content of the document 7 on the display apparatus 4. The setting-sheet output unit 101 may perform this checking process on the basis of the content management information 112 and the distribution setting information 113 of the other documents stored in the memory 11 of the content managing server 1. Alternatively, the content managing server 1 may manage the display schedule.

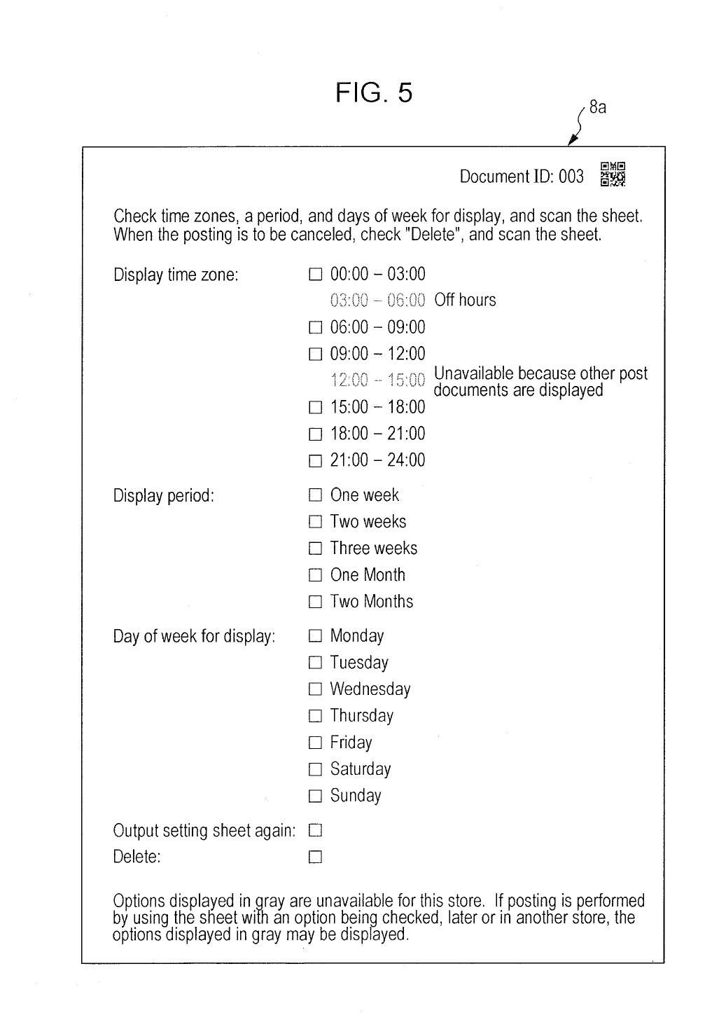

As illustrated in FIG. 4B, the setting-sheet output unit 101 causes the image forming apparatus 2 to output a setting sheet 8 which is used to set a distribution condition of the document information 111 and which reflects the above-described response (S4). The setting sheet 8 has a configuration, for example, illustrated in FIG. 5 described below.

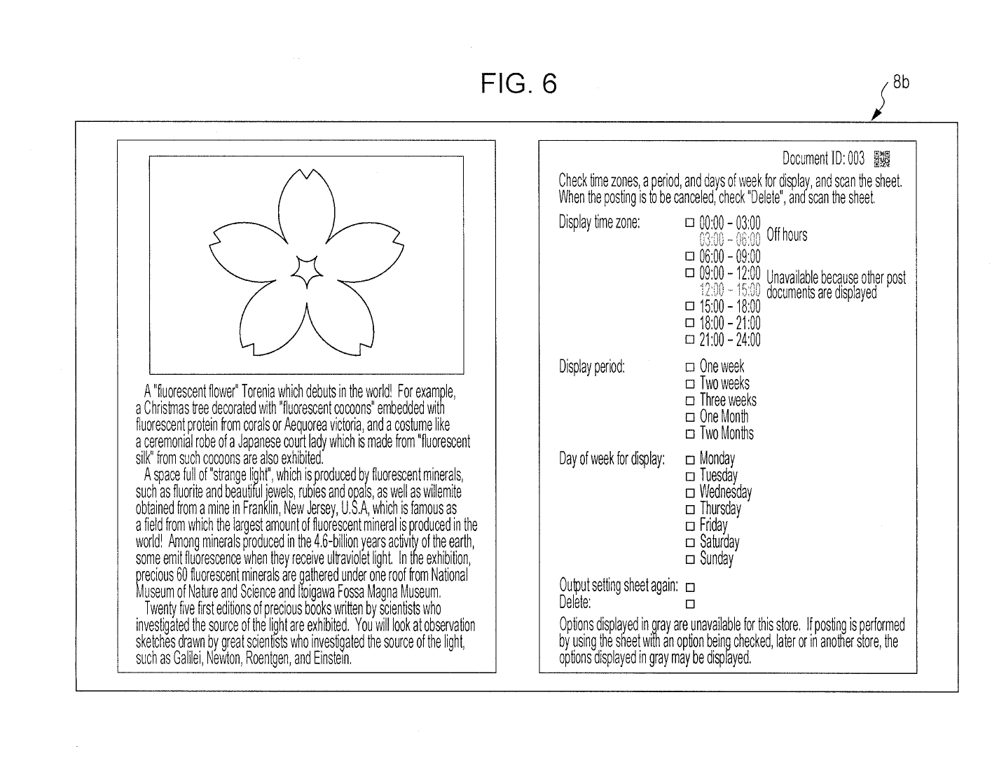

FIG. 5 is a schematic view of an exemplary configuration of the setting sheet 8. FIG. 6 is a schematic view of another exemplary configuration of the setting sheet 8.

In a setting sheet 8a which is an exemplary setting sheet 8, for example, when a time zone is unavailable because the time zone corresponds to “off hours”, such as the time zone “03:00 to 06:00”, or because the time zone is “unavailable because other post documents are displayed”, such as the time zone “12:00 to 15:00”, the time zone is displayed in gray and no checkboxes are provided so that it is indicated that it is impossible to perform setting for the time zone. Options for setting items, such as “Display time zone”, “Display period”, and “Day of week for display” are displayed along with checkboxes. An item “Output setting sheet again” is an item used in “(5) reregistration operations”, and will be described below. An item “Delete” is an item for deleting the document information 111 corresponding to the scanned document 7.

On the back side of the setting sheet 8a, a copy of the posted document 7 may be printed so that the user 6 may check which document corresponds to the setting sheet 8a after the posting operations. Like a setting sheet 8b illustrated in FIG. 6 described below, the posted document 7 and the setting items may be printed on the same side.

Then, as illustrated in FIG. 4C, the user 6 writes a distribution time or the like of the document information 111 on the setting sheet 8, and causes the image forming apparatus 2 to scan the setting sheet 8. For example, assume that the checkboxes for “06:00 to 09:00” and “15:00 to 18:00” in “Display time zone” are checked, and that the checkbox “One week” in “Display period” is checked.

The image forming apparatus 2 scans the setting sheet 8 to generate distribution setting information, and transmits the distribution setting information to the content managing server 1.

The setting receiving unit 102 receives the distribution setting information from the image forming apparatus 2, and stores the distribution setting information as the distribution setting information 113 in the memory 11 (S5). The file name of the stored distribution setting information 113 is input in the content management information 112. In the example illustrated in FIG. 3, the file name “GHI” is input in the distribution setting information field for the document ID “003”.

### (3) Charging Operations

A case in which the checkbox “Delete” is not checked on the setting sheet 8 will be described (NO in step S6). After the setting receiving unit 102 stores the distribution setting information 113, the charging unit 103 performs a charging operation on the image forming apparatus 2 (S7).

The image forming apparatus 2 displays the amount of money required to be paid, on a display thereof.

As illustrated in FIG. 4D, the user 6 pays the charge, for example, by putting money into a slot provided on the image forming apparatus 2, or by holding a card against a prepaid card reader.

When the charge is paid, the image forming apparatus 2 transmits the information describing that the charge has been paid, to the content managing server 1.

### (4) Distribution Operations

Then, when the charging unit 103 completes the charging process, the content distributing unit 104 distributes the document information 111 and the distribution setting information 113 to the signage controller 3 (S8).

The signage controller 3 displays the document information on the display apparatus 4 on the basis of the distribution setting information. In the above-described example, the document information 111 is displayed in the time zones “06:00 to 09:00” and “15:00 to 18:00” in one week.

In step S6, when the checkbox “Delete” is checked (YES in step S6), the setting receiving unit 102 deletes the document information 111 received in step S1, from the memory 11 (S9).

### (5) Reregistration Operations

The reregistration operations described below are operations performed when the setting sheet 8 is scanned again after “(1) document-information registration operations”, “(2) distribution-setting-information registration operations”, “(3) charging operations”, and “(4) distribution operations” which are described above are performed.

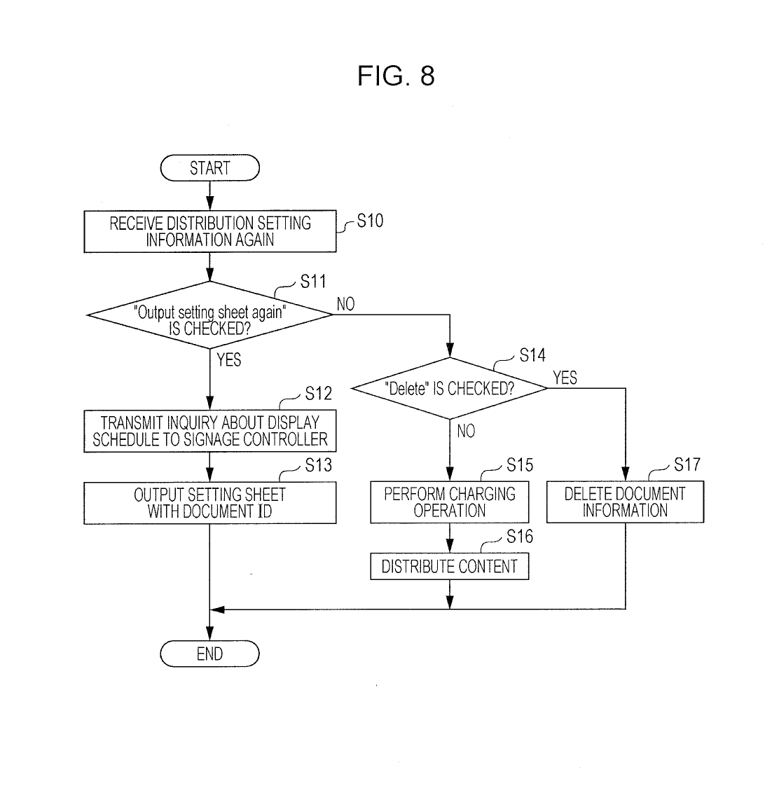

FIG. 8 is a flowchart of exemplary operations performed by the content managing server 1 when posting is performed again.

### (5-1) Outputting Setting Sheet Again

To change the condition which has been set, the user 6 uses the image forming apparatus 2 to scan the setting sheet 8 which was used before. A case in which the checkbox “Output setting sheet again” is checked will be described.

The image forming apparatus 2 scans the setting sheet 8 to generate distribution setting information, and transmits the distribution setting information to the content managing server 1.

The setting receiving unit 102 of the content managing server 1 receives the distribution setting information from the image forming apparatus 2 (S10).

If the checkbox “Output setting sheet again” is checked (YES in step S11), the setting-sheet output unit 101 transmits an inquiry about a display schedule to the signage controller 3 to check the display schedule of the signage controller 3 (S12). When the content managing server 1 manages the display schedule, the checking process is performed in the content managing server 1.

Then, the setting-sheet output unit 101 causes the image forming apparatus 2 to output a setting sheet 8 which is used to set a distribution condition of the document information 111 again and which reflects the response from the signage controller 3 or the content managing server 1 (S13).

When the user 6 writes a new condition on the newly output setting sheet 8 and causes the image forming apparatus 2 to scan the setting sheet 8, the content managing server 1 performs operations described in steps S5 to S9. Thus, the old distribution setting information 113 is updated.

### (5-2) Resetting

If the checkbox “Output setting sheet again” is not checked in step S11 (NO in step S11), and if the checkbox “Delete” is not checked (NO in step S14), the charging unit 103 performs a charging process on the image forming apparatus 2 (S15), and the content distributing unit 104 refers to the content management information 112 on the basis of the document ID, and distributes the document information with the distribution setting information 113 having the same condition as that transmitted the last time, to the signage controller 3 (S16).

If these operations are performed after the period which is set first elapses, the user 6 does not have to perform the same setting procedure again. It is assumed that the above-described operations are performed on the same image forming apparatus 2. When the operations are performed on a different image forming apparatus 2, the document information 111 with the distribution setting information 113 having the same condition as that used the last time may be transmitted to a different signage controller 3 associated with the different image forming apparatus 2. In this case, these operations may be performed before the period which is set first elapses. A setting item “Distribution area” may be provided, and distribution to signage controllers 3 installed in multiple places may be performed.

### (5-3) Deleting

If the checkbox “Delete” is checked in step S14 (YES in step S14), the setting receiving unit 102 refers to the content management information 112, and deletes the document information 111 corresponding to the document ID from the memory 11 (S17). The document information 111 is also deleted from the signage controller 3. Then, the distribution setting information 113 and the display schedule are updated.

### Second Exemplary Embodiment

A second exemplary embodiment is different from the first exemplary embodiment in that a distribution condition is set by operating an operation unit of the image forming apparatus 2. In the description below, operations similar to those in the first exemplary embodiment will not be described. The operations “(4) distribution operations” and “(5) reregistration operations” which are similar to those in the first exemplary embodiment will not be described.

Actions according to the second exemplary embodiment will be described by classifying them into (1) document-information registration operations, (2) distribution-setting-information registration operations, and (3) charging operations.

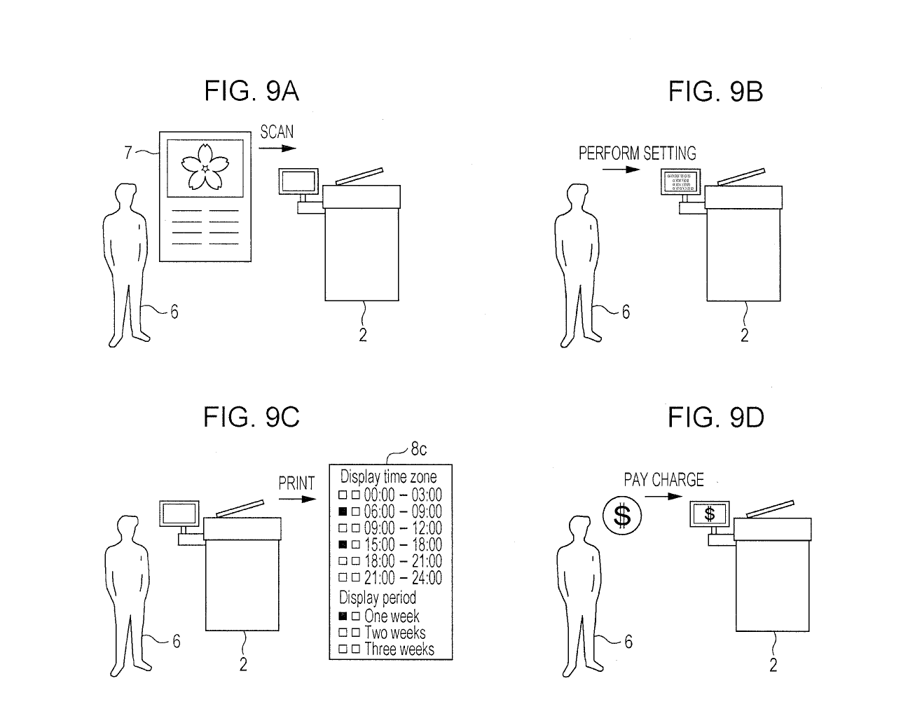

FIGS. 9A to 9D are diagrams for describing exemplary operations performed in the content managing system according to the second exemplary embodiment.

### (1) Document-Information Registration Operations

As illustrated in FIG. 9A, the user 6 uses the image forming apparatus 2 to scan the document 7.

The image forming apparatus 2 scans the document 7 to generate document information, and transmits the document information to the content managing server 1.

The document receiving unit 100 of the content managing server 1 receives the document information from the image forming apparatus 2, and stores the document information as the document information 111 in the memory 11.

At that time, the document receiving unit 100 inputs a new document ID in the content management information 112 illustrated in FIG. 3, and associates the document ID with the document information.

### (2) Distribution-Setting-Information Registration Operations

Then, the setting receiving unit 102 transmits an inquiry about a display schedule to the signage controller 3 to check the display schedule of the signage controller 3. When the content managing server 1 manages the display schedule, the checking process is performed in the content managing server 1.

Then, as illustrated in FIG. 9B, the setting receiving unit 102 displays a setting screen which is used to set a distribution condition of the document information 111 and which reflects the response from the signage controller 3 or the content managing server 1, on the display of the image forming apparatus 2. The setting screen has a configuration, for example, similar to that of the example illustrated in FIG. 5.

Then, the user 6 inputs a distribution time or the like of the document information 111 on the setting screen.

The image forming apparatus 2 generates distribution setting information from the setting information, and transmits the distribution setting information to the content managing server 1.

The setting receiving unit 102 receives the distribution setting information from the image forming apparatus 2, and stores the distribution setting information as the distribution setting information 113 in the memory 11. The file name of the stored distribution setting information 113 is input to the content management information 112.

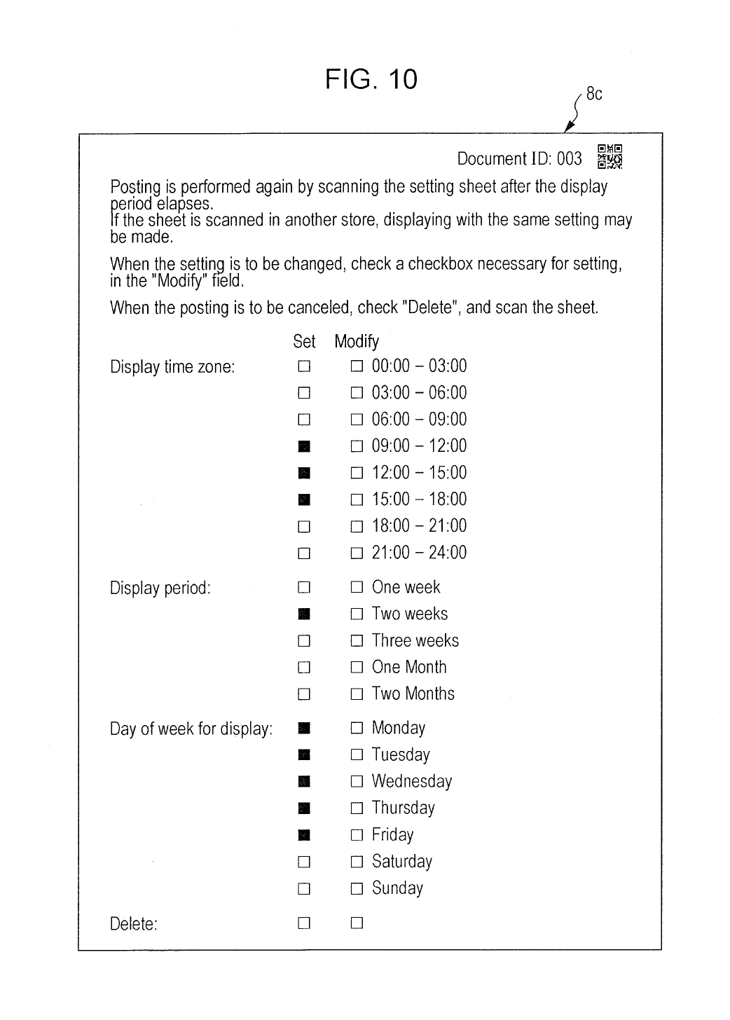

As illustrated in FIG. 9C, the setting-sheet output unit 101 causes the image forming apparatus 2 to output a setting sheet 8c which reflects the distribution setting information 113. The setting sheet 8c is used to reregister setting information, and has a configuration illustrated in FIG. 10 described below.

FIG. 10 is a schematic view of an exemplary configuration of the setting sheet 8c.

In the setting sheet 8c, selected items among the setting items “Display time zone”, “Display period”, “Day of week for display”, and the like are displayed with checked checkboxes, and options which may be used for modification are also displayed with unchecked checkboxes. The item “Delete” is one for deleting the document information 111 corresponding to the scanned document 7.

On the back side of the setting sheet 8c, a copy of the posted document 7 may be printed so that the user 6 may check which document corresponds to the setting sheet 8c. As in the setting sheet 8b illustrated in FIG. 6, the posted document 7 and the setting items may be printed on the same side.

### (3) Charging Operations

After the setting sheet 8c is output from the image forming apparatus 2, the charging unit 103 performs a charging operation on the image forming apparatus 2.

The image forming apparatus 2 displays the amount of money required to be paid, on the display.

As illustrated in FIG. 9D, the user 6 pays the charge, for example, by putting money into the slot provided on the image forming apparatus 2, or by holding a card against the prepaid card reader.

When the charge is paid, the image forming apparatus 2 transmits the information describing that the charge has been paid, to the content managing server 1.

### Third Exemplary Embodiment

A third exemplary embodiment is different from the first exemplary embodiment in that document information is uploaded from a terminal, that a distribution condition is set from a terminal, and that a setting sheet is printed by a printer connected to a terminal.

In the description below, operations similar to those in the first exemplary embodiment will not be described. The operations “(4) distribution operations” and “(5) reregistration operations” which are similar to those in the first exemplary embodiment will not be described.

Actions according to the third exemplary embodiment will be described by classifying them into (1) document-information registration operations, (2) distribution-setting-information registration operations, and (3) charging operations.

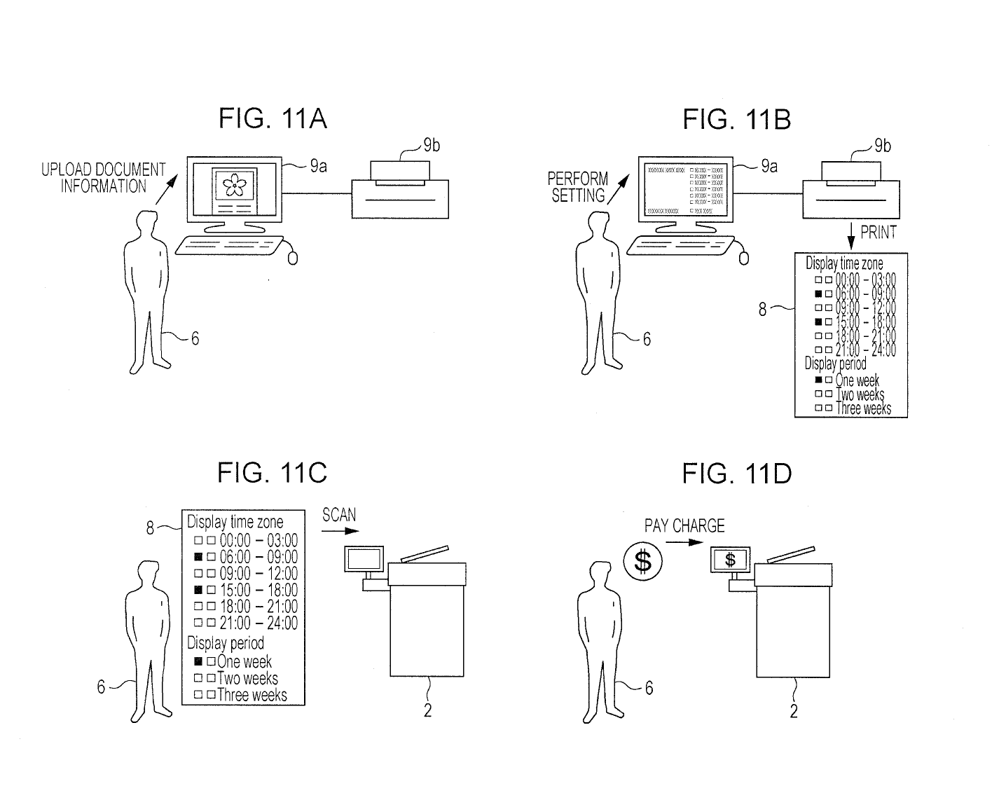

FIGS. 11A to 11D are diagrams for describing exemplary operations performed in the content managing system according to the third exemplary embodiment.

### (1) Document-Information Registration Operations

As illustrated in FIG. 11A, the user 6 operates a terminal 9a so that document information is uploaded. The uploading operation is performed by using a dedicated application, a Web browser, or the like.

The terminal 9a transmits the document information to the content managing server 1.

The document receiving unit 100 of the content managing server 1 receives the document information from the terminal 9a, and stores the document information as the document information 111 in the memory 11.

At that time, the document receiving unit 100 inputs a new document ID in the content management information 112 illustrated in FIG. 3, and associates the document ID with the document information.

### (2) Distribution-Setting-Information Registration Operations

Then, the setting receiving unit 102 transmits an inquiry about a display schedule to the signage controller 3 to check the display schedule of the signage controller 3. When the content managing server 1 manages the display schedule, the checking process is performed in the content managing server 1.

Then, as illustrated in FIG. 11B, the setting receiving unit 102 displays a setting screen which is used to set a distribution condition of the document information 111 and which reflects the response from the signage controller 3 or the content managing server 1, on a display of the terminal 9a. The setting screen has a configuration, for example, similar to that of the example illustrated in FIG. 5.

Then, the user 6 inputs a distribution time or the like of the document information 111 on the setting screen.

The terminal 9a generates distribution setting information from setting information, and transmits the distribution setting information to the content managing server 1.

The setting receiving unit 102 receives the distribution setting information from the image forming apparatus 2, and stores the distribution setting information as the distribution setting information 113 in the memory 11. The file name of the stored distribution setting information 113 is input to the content management information 112.

Then, the setting-sheet output unit 101 outputs the setting sheet 8c which reflects the distribution setting information 113, from a printer 9b connected to the terminal 9a. The setting sheet 8c is used to reregister setting information. The setting sheet 8c is output from the printer 9b connected to the terminal 9a. Alternatively, the document ID may be displayed on the terminal, or may be transmitted to a portable terminal or the like through email. The document ID which is input from the operation unit of the image forming apparatus 2 may be used to output the setting sheet 8c from the image forming apparatus 2.

### (3) Charging Operations

As illustrated in FIG. 11C, the user 6 uses the image forming apparatus 2 to scan the setting sheet 8c.

The image forming apparatus 2 scans the setting sheet 8c and transmits the scanned information to the content managing server 1.

The content managing server 1 refers to the content management information 112, and specifies the distribution setting information 113 and the document information 111 which the user 6 wants to distribute, on the basis of the information of the setting sheet 8c.

Then, the charging unit 103 performs a charging process on the image forming apparatus 2.

The image forming apparatus 2 displays the amount of money to be paid, on the display.

As illustrated in FIG. 11D, the user 6 pays the charge, for example, by putting money into the slot provided on the image forming apparatus 2, or by holding a card against the prepaid card reader.

When the charge is paid, the image forming apparatus 2 transmits the information describing that the charge has been paid, to the content managing server 1.

### Other Exemplary Embodiments

The present invention is not limited to the above-described exemplary embodiments. Various modifications may be made without departing from the gist of the present invention. The first to third exemplary embodiments described above may be combined with one another as appropriate.

A procedure and a configuration for checking if information in the document 7 is not contrary to public policy or morality and is appropriate may be provided. For example, before document information is transmitted from the image forming apparatus 2 to the content managing server 1, the document information is to be transmitted by way of a server for checking, which has a check function, and the server for checking checks if the document information is appropriate. For example, the checking procedure is performed as follows.

The server for checking separates text portions from image portions by performing image processing on the document information. Then, for the text portions, a check process is performed by checking a word and the sequence of strings before and after the word against a preregistered database. For the image portions, a check process is performed, for example, by retrieving similar images and analyzing the amount of skin portions.

When the server for checking determines that the document information is inappropriate, the content managing server 1 causes the image forming apparatus 2 to print, instead of the setting sheet 8, printed material on which a message that it is not possible to post the document because it is inappropriate is described. Thus, the user 6 may recognize that the document 7 is inappropriate.

In the above-described exemplary embodiments, the functions of the units 100 to 104 of the controller 10 are implemented by using programs. All or some of the units may be implemented by using hardware such as an application-specific integrated circuit (ASIC). Programs used in the above-described exemplary embodiments may be provided by storing the programs in a recording medium such as a compact disc-read-only memory (CD-ROM). Replacement, deletion, addition, and the like of the steps described in the above-described exemplary embodiments may be performed as long as the gist of the present invention is not changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for content management, the process comprising:
receiving an instruction to reset or update distribution setting information of document information or an instruction to delete the document information, by causing an image forming apparatus to read again a setting sheet after the document information and the distribution setting information of the document information are received, the setting sheet being a sheet on which the distribution setting information is described; and
distributing the document information and the reset or updated distribution setting information to a signage controller for displaying the document information, when the instruction to reset or update the distribution setting information is received.

2. The non-transitory computer readable medium according to claim 1, the process further comprising:
after the instruction to reset or update the distribution setting information is received, performing a charging process by using the image forming apparatus,
wherein, after the charging process is completed, the distributing distributes the document information and the reset or updated distribution setting information to the signage controller.

3. The non-transitory computer readable medium according to claim 1, the process further comprising;
receiving the document information from the image forming apparatus, the document information being obtained by scanning a document by using the image forming apparatus;
causing the image forming apparatus to output the setting sheet for setting a distribution condition of the document information; and
receiving information as the distribution setting information, the information being obtained by scanning writing on the setting sheet by using the image forming apparatus.

4. The non-transitory computer readable medium according to claim 2, the process further comprising;
receiving the document information from the image forming apparatus, the document information being obtained by scanning a document by using the image forming apparatus;
causing the image forming apparatus to output the setting sheet for setting a distribution condition of the document information; and
receiving information as the distribution setting information, the information being obtained by scanning writing on the setting sheet by using the image forming apparatus.

5. The non-transitory computer readable medium according to claim 1, the process further comprising:
receiving the document information from the image forming apparatus, the document information being obtained by scanning a document by using the image forming apparatus; and
displaying a screen on a display of the image forming apparatus, the screen being used to set a distribution condition of the document information, and receiving information as the distribution setting information, the information being input in accordance with the screen.

6. The non-transitory computer readable medium according to claim 2, the process further comprising:
receiving the document information from the image forming apparatus, the document information being obtained by scanning a document by using the image forming apparatus; and
displaying a screen on a display of the image forming apparatus, the screen being used to set a distribution condition of the document information, and receiving information as the distribution setting information, the information being input in accordance with the screen.

7. The non-transitory computer readable medium according to claim 1, the process further comprising:
receiving the document information transmitted from a terminal apparatus; and
displaying a screen on a display of the terminal apparatus, the screen being used to set a distribution condition of the document information, and receiving information as the distribution setting information, the information being input in accordance with the screen.

8. The non-transitory computer readable medium according to claim 2, the process further comprising:
receiving the document information transmitted from a terminal apparatus; and
displaying a screen on a display of the terminal apparatus, the screen being used to set a distribution condition of the document information, and receiving information as the distribution setting information, the information being input in accordance with the screen.

9. An information processing apparatus comprising:
a setting receiving unit that, by causing an image forming apparatus to read again a setting sheet after document information and distribution setting information of the document information are received, receives an instruction to reset or update the distribution setting information or an instruction to delete the document information, the setting sheet being a sheet on which the distribution setting information is described; and
a distributing unit that, when the setting receiving unit receives the instruction to reset or update the distribution setting information, distributes the document information and the reset or updated distribution setting information to a signage controller for displaying the document information.

10. An information processing method comprising:
receiving an instruction to reset or update distribution setting information of document information or an instruction to delete the document information, by causing an image forming apparatus to read again a setting sheet after the document information and the distribution setting information of the document information are received, the setting sheet being a sheet on which the distribution setting information is described; and
distributing the document information and the reset or updated distribution setting information to a signage controller for displaying the document information, when the instruction to reset or update the distribution setting information is received.
